(19) United States
(12) Patent Application Publication
(10) Pub. No.: US 2026/0092639 A1
(43) Pub. Date: Apr. 2, 2026

(54) CHAIN

(71) Applicant: DAIDO KOGYO CO., LTD., Ishikawa (JP)

(72) Inventor: Tetsuya KAWAI, Ishikawa (JP)

(21) Appl. No.: 19/329,815

(22) Filed: Sep. 16, 2025

(30) Foreign Application Priority Data
Sep. 27, 2024 (JP) 2024-169378

(51) Int. Cl. F16G 13/07; F16H 7/06

(52) U.S. Cl. CPC F16G 13/07; F16H 7/06

(57) ABSTRACT

A chain is formed by alternately connecting an inner link and an outer link. An inner plate of the inner link has a first sliding contact region that comes into sliding contact with a guide and a non-sliding contact region that does not come into sliding contact with the guide. The first sliding contact region is formed in a range shorter than a chain pitch. In the first sliding contact region, the inner plate has a height greater than a height of an outer plate in terms of height from a pitch line. In the non-sliding contact region, the outer plate has a height greater than a height of the inner plate. When a height of the inner plate is defined as a first height h1, and a height of the outer plate is defined as a second height h2, a relationship of h1 > h2 is satisfied.

### FIELD OF INVENTION

The present invention relates to a chain for power transmission.

### BACKGROUND ART

A chain for power transmission, in which an outer link in which a pair of outer plates are connected by a pin and an inner link in which a pair of inner plates are connected by a bushing are alternately connected by insertion of the pin into the bushing, is known. Japanese Patent No. 5259775 discloses a chain that reduces friction loss with respect to a chain guide by provision of a sliding contact arc region in sliding contact with the chain guide on a back surface of the inner plate.

In the chain of Japanese Patent No. 5259775, the sliding contact arc region is set to be longer than a chain pitch. However, when width of a sliding contact region of the chain with respect to the chain guide is long, there is a case where friction cannot be sufficiently reduced. On the other hand, when width of the sliding contact region is shortened, surface pressure applied by the chain to the chain guide increases, and wear of a sliding contact surface of the chain guide may be easily progressed.

### SUMMARY OF THE INVENTION

An object of the present invention is to provide a chain capable of achieving both reduction of friction with respect to a chain guide and suppression of wear of the chain guide.

A chain according to one aspect of the present invention is a chain including a plurality of outer links including a pair of outer plates and a pair of pins connecting the pair of outer plates, and a plurality of inner links including a pair of inner plates and a pair of bushings connecting the pair of inner plates, the outer links and the inner links being alternately connected by insertion of the pins into the bushings, in which the inner plate includes a back surface having a first sliding contact region that comes into sliding contact with a guide that guides the chain when the chain is driven, and a non-sliding contact region that does not come into sliding contact with the guide, the first sliding contact region is formed in a range shorter than a chain pitch by a plurality of arcs that bulge in a same direction, in the first sliding contact region, the inner plate has a height greater than a height of the outer plate in terms of height from a pitch line connecting centers of a pair of pin holes that are opened in the outer plate and through which the pair of pins pass, in the non-sliding contact region, the outer plate has a height greater than a height of the inner plate in terms of height from the pitch line, and when a height from the pitch line to a highest point of the inner plate in the first sliding contact region is defined as a first height h1, and a height from the pitch line to a highest point of the outer plate in the non-sliding contact region is defined as a second height h2, a relationship of h1 > h2 is satisfied.

### BRIEF DESCRIPTION OF THE DRAWINGS

FIG. 1 is a front view illustrating an example of a timing chain transmission device;

FIG. 2 is a partially broken plan view of a timing chain which is an embodiment of a chain according to the present invention;

FIG. 3 is a side view of the timing chain illustrated in FIG. 2;

FIG. 4 is an enlarged view of a main part of FIG. 3 with first height h1 and second height h2 added;

FIG. 5 is an enlarged view of a main part of FIG. 4 for describing a depressed portion for storing oil;

FIG. 6 is schematic diagrams for describing a contact state of the timing chain of the present embodiment with respect to a shoe; and

FIG. 7 is a diagram illustrating a sliding state of the timing chain of the present embodiment with respect to a guide member.

### DETAILED DESCRIPTION

Hereinafter, an embodiment of the present disclosure will be described in detail with reference to the drawings. A chain according to the present invention is a chain for power transmission applicable to a power transmission mechanism incorporated in a moving vehicle such as a four-wheeled or two-wheeled automobile, a heavy machine, an industrial machine, or the like. In the embodiment described below, a timing chain assembled to an internal combustion engine is exemplified as an example of the chain according to the present invention.

### Configuration of timing chain transmission device

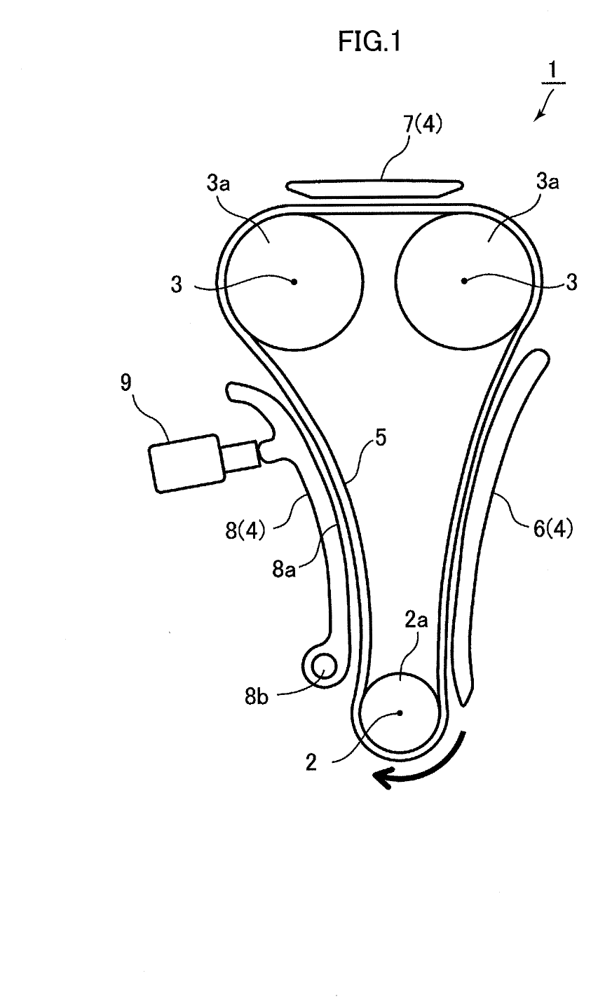

FIG. 1 is a front view illustrating an example of a timing chain transmission device 1. The timing chain transmission device 1 is assembled to, for example, an automobile engine. The engine is a power source for driving an automobile to travel, and includes a cylinder and a piston (not illustrated), a crankshaft 2, and a pair of camshafts 3. The crankshaft 2 is connected to the piston, and is rotationally driven around an axis according to reciprocating motion of the piston in the cylinder. Two of the camshafts 3 drive opening and closing of an intake valve and an exhaust valve attached to the cylinder. The camshaft 3 rotates in conjunction with rotation of the crankshaft 2.

The timing chain transmission device 1 includes a crank sprocket 2a, a pair of cam sprockets 3a, a guide member 4, and a timing chain 5. The crank sprocket 2a is attached to an axial end of the crankshaft 2 and rotates integrally with the crankshaft 2. A pair of the cam sprockets 3a are attached to an axial end of a pair of the camshafts 3, and rotate integrally with the camshafts 3. The timing chain 5 is wound between the crank sprocket 2a and a pair of the cam sprockets 3a. The timing chain 5 transmits power of the crankshaft 2 to the camshaft 3. That is, the timing chain 5 circulates by rotation of the crank sprocket 2a, and the cam sprocket 3a is driven to rotate by the circulation of the timing chain 5, so that power of the crankshaft 2 is transmitted to the camshaft 3.

The guide member 4 is arranged on an outer periphery of the timing chain 5 and serves as a guide for guiding the circulation of the timing chain 5. The guide member 4 includes a first chain guide 6, a second chain guide 7, and a tensioner arm 8. When the outer peripheral side of the timing chain 5 comes into sliding contact with each of the guide members 4, swinging of the timing chain 5 is suppressed, and stable circulation is secured.

As indicated by an arrow in FIG. 1, in a case where the timing chain 5 circulates clockwise, a portion between the crank sprocket 2a and a left one of the cam sprockets 3a is the slack side of the timing chain 5, and the remaining portion is the tight side due to application of drive load of the camshaft 3. The chain guides 6 and 7 are arranged on the tight side, and the tensioner arm 8 is arranged on the slack side. The chain guides 6 and 7 are fixed to an engine block. The tensioner arm 8 is a member that applies tension to the timing chain 5, and includes a shoe 8a and a support shaft 8b. The shoe 8a is in sliding contact with the timing chain 5. The support shaft 8b is attached to an engine block and swingably supports one end side of the tensioner arm 8. A plunger of a chain tensioner 9 abuts on another end side of the tensioner arm 8. Appropriate tension is applied to the timing chain 5 from the chain tensioner 9 via the tensioner arm 8.

### Overall configuration of timing chain

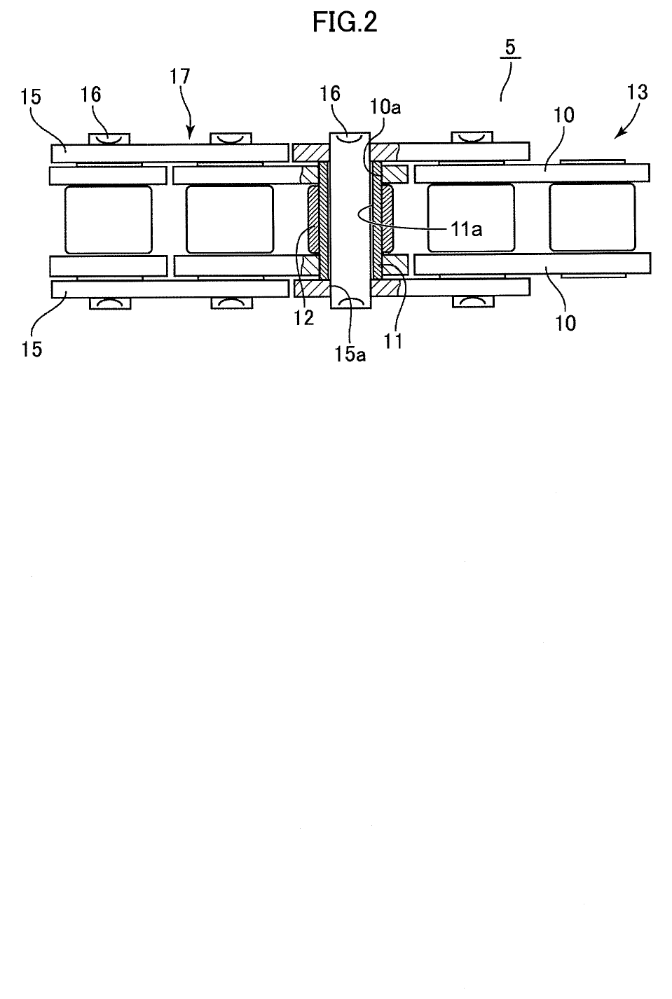

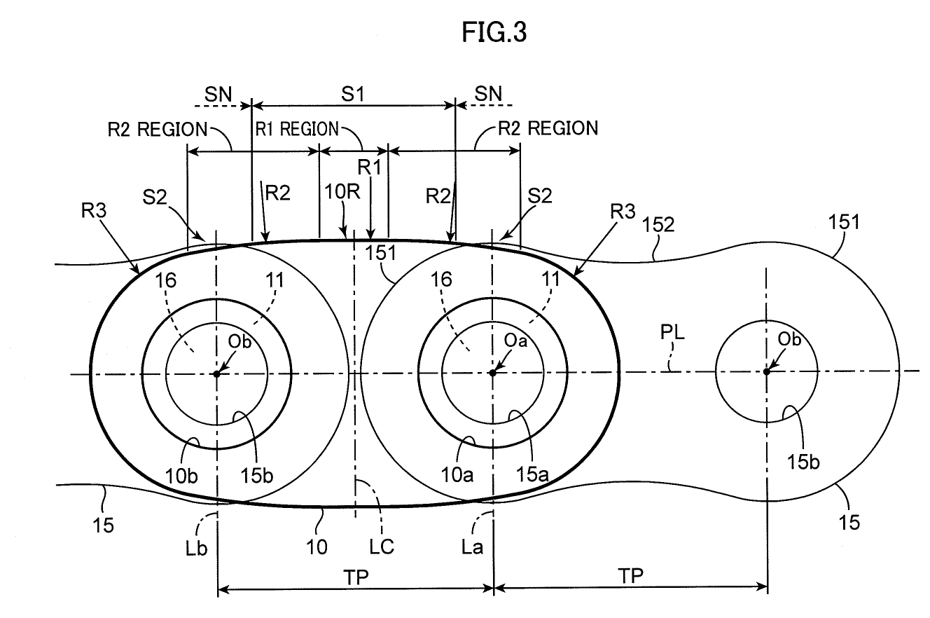

An overall configuration of the timing chain 5 will be described. FIG. 2 is a partially broken plan view of the timing chain 5, and FIG. 3 is a side view of the timing chain 5. The timing chain 5 is an endless structure in which a plurality of inner links 13 and a plurality of outer links 17 are alternately connected. The inner link 13 includes a pair of inner plates 10, a pair of bushings 11, and a pair of rollers 12. The outer link 17 includes a pair of outer plates 15 and a pair of pins 16. Note that FIG. 3 illustrates a side view of a state in which one of the outer plates 15, the bushing 11, and the pin 16 are removed. Further, in a side view, most of the inner plate 10 is covered by the outer plate 15 and cannot be seen in practice, but in FIG. 3, it is illustrated as being visible for convenience of description. The inner plate 10 is indicated by a thick line, and the outer plate 15 is indicated by a thin line.

Both of a pair of the inner plates 10 have a substantially elliptical shape in a side view, and are arranged in parallel. A first bushing hole 10a is formed on one end side in a longitudinal direction of the inner plate 10, and a second bushing hole 10b is formed on another end side. Both ends of a pair of the bushings 11 are press-fitted into the bushing holes 10a and 10b, so that a pair of the inner plates 10 are connected. The bushing 11 has a through hole 11a through which the pin 16 is inserted. The roller 12 is rotatably externally fitted to the bushing 11 between a pair of the inner plates 10.

Both of a pair of the outer plates 15 have a shape similar to the number "8" in which the center in a longitudinal direction is recessed in a side view, and are arranged in parallel with the inner link 13 interposed between them. A first pin hole 15a is formed on one end side in a longitudinal direction of the outer plate 15, and a second pin hole 15b is formed on another end side. Both ends of a pair of the pins 16 are press-fitted into the pin holes 15a and 15b and then fixed by staking, so that a pair of the outer plates 15 are connected. Both end portions of the pin 16 are fixed to the pin holes 15a and 15b in a state of being inserted into the through hole 11a. By inserting the pin 16 into the through hole 11a, the inner link 13 and the outer link 17 are alternately connected.

### Detailed configuration of timing chain

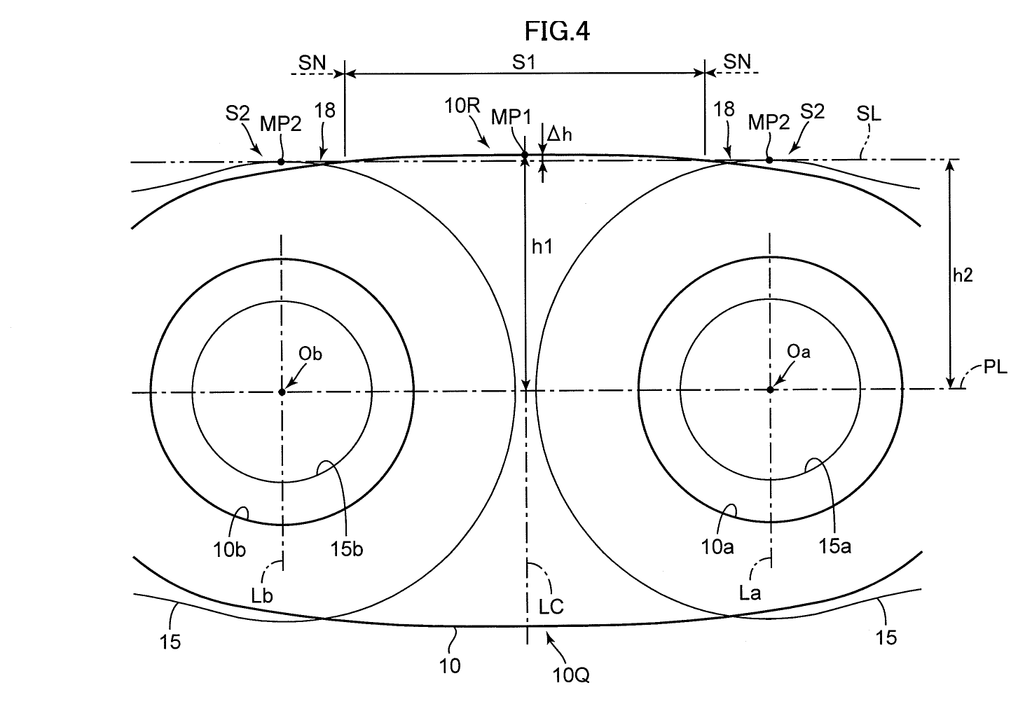

A configuration of the timing chain 5 will be described in more detail with reference to FIG. 4 which is an enlarged view of a main part of FIG. 3. The inner plate 10 has a substantially elliptical shape symmetrical about a pitch line PL as a symmetry axis. When the center of the first pin hole 15a opened in the outer plate 15 is Oa and the center of the second pin hole 15b is Ob, the pitch line PL is a line connecting the centers Oa and Ob. Note that the longitudinal direction of the inner plate 10 and the outer plate 15 is a direction in which the pitch line PL extends. A chain pitch TP of the timing chain 5 is length between the center Oa and the center Ob. Note that, in the present embodiment, description will be made assuming that the shape is symmetrical with the pitch line PL as a symmetry axis, but the shape does not need to have symmetrical.

A peripheral surface of the inner plate 10 on the outer peripheral side with respect to the pitch line PL of the timing chain 5 is a back surface 10R in sliding contact with the guide member 4. A peripheral surface of the inner plate 10 on the inner peripheral side with respect to the pitch line PL is an inner surface 10Q that is not in sliding contact with the guide member 4. The back surface 10R and the inner surface 10Q have symmetrical shapes with respect to the pitch line PL. Further, the inner plate 10 has a left-right symmetrical shape with respect to a center line LC in a lateral direction extending in a direction orthogonal to the pitch line PL at a half pitch position of the chain pitch TP, the center line LC being a symmetry axis.

The inner plate 10 has a first sliding contact region S1 and a non-sliding contact region SN on the back surface 10R. The first sliding contact region S1 is in sliding contact with the guide member 4 that guides the timing chain 5 when the timing chain 5 is driven. On the other hand, the non-sliding contact region SN is a region that does not come into sliding contact with the guide member 4 even when the timing chain 5 is driven. The first sliding contact region S1 is a certain region in the longitudinal direction of the inner plate 10 about the center line LC. The non-sliding contact region SN is located on the right side and the left side of the first sliding contact region S1.

The first sliding contact region S1 is formed in a range shorter than the chain pitch TP. Such range setting of the first sliding contact region S1 is intended to reduce friction with respect to the guide member 4. However, if length of the first sliding contact region S1 is too short, surface pressure applied to the guide member 4 increases, and the shoe 8a of the tensioner arm 8 is worn early, for example. That is, reduction in friction and suppression of wear of the guide member have a trade-off relationship. In view of this point, the first sliding contact region S1 is desirably set to a length of 73% to 86% of the chain pitch TP in a length in a direction along the pitch line PL. By this length setting, it is possible to achieve both reduction of friction and suppression of wear in a well-balanced manner.

The first sliding contact region S1 includes a plurality of arcs that bulge in the same direction. Specifically, a first arc R1 extending to both the left and right sides across the center line LC and a pair of second arcs R2 extending outward from both ends of the first arc R1 are included. Both the first arc R1 and the second arc R2 are arcs that bulge in a direction away from the pitch line PL, that is, toward the outer peripheral side. The first arc R1 is an arc having a relatively large radius. The radius of the first arc R1 is larger than a radius of the second arc R2. FIG. 3 illustrates an R1 region constituted by the first arc R1 and an R2 region constituted by the second arc R2 on the back surface 10R.

The R1 region is located near the center line LC. The R2 region on the right side of the R1 region extends from a right end of the R1 region to a position beyond a line La passing through the center Oa of the first pin hole 15a and orthogonal to the pitch line PL. A third arc R3 formed of an arc concentric with the bushing hole 10a is continuously provided at a right end of the R2 region. The R2 region on the left side of the R1 region extends from ae left end of the R1 region to a position beyond a line Lb passing through the center Ob of the second pin hole 15b and orthogonal to the pitch line PL. The third arc R3 on the left side is continuously provided at a left end of the R2 region. As an example, a radius of the first arc R1 is 100 mm, a radius of the second arc R2 is 20 mm, and a radius of the third arc is 3.5 mm.

The first sliding contact region S1 includes the first arc R1 and a part of two of the second arcs R2. Length occupied by the first arc R1 in the first sliding contact region S1 is desirably 5% to 48% of a total length of the first sliding contact region S1 in a direction along the pitch line PL. By arranging an arc having a large radius, that is, the first arc R1 having small degree of curvature with length within the above range, the friction reduction and the wear suppression can be realized in a well-balanced manner. The first sliding contact region S1 only needs to be formed by continuously providing a plurality of arcs bulging in a direction away from the pitch line PL, and may be formed by continuously providing three or more arcs. Further, a short straight portion connecting a plurality of arcs may be included in a part of the first sliding contact region S1.

The outer plate 15 includes a pair of circular portions 151 located around a pair of the pin holes 15a and 15b and a recessed portion 152 located in a central region between a pair of the circular portions 151. The outer plate 15 has a symmetrical shape with respect to the pitch line PL between the back surface 10R side and the inner surface 10Q side. Further, the outer plate 15 has a left-right symmetrical shape with respect to a center line extending in a direction orthogonal to the pitch line PL at a half pitch position of the chain pitch TP, the center line being a symmetry axis. The recessed portion 152 is recessed toward the pitch line PL. The outer plate 15 has a contour shape in which a central region in a direction along the pitch line PL is narrowed by having the recessed portion 152.

The outer plate 15 includes second sliding contact regions S2 that can come into sliding contact with the guide member 4 at both end portions of the recessed portion 152. The second sliding contact region S2 is constituted by a part of a plurality of arcs constituting the circular portion 151. A part of a plurality of the arcs is an arc portion adjacent to the recessed portion 152. As shown in FIG. 3, in a side view, the second sliding contact region S2 is located in a region corresponding to the non-sliding contact region SN of the inner plate 10, and is located on both sides of the first sliding contact region S1.

A height relationship between the first sliding contact region S1 and the second sliding contact region S2 from the pitch line PL will be described with reference to FIG. 4, which is an enlarged view of a main part of FIG. 3. In the first sliding contact region S1, the inner plate 10 has a greater height than the outer plate 15 in terms of height from the pitch line PL. On the other hand, in the non-sliding contact region SN, the outer plate 15 has a greater height than the inner plate 10 in terms of height from the pitch line PL.

A height from the pitch line PL to a highest point MP1 of the inner plate 10 in the first sliding contact region S1 is defined as a first height h1. A height from the pitch line PL to a highest point MP2 of the outer plate 15 in the non-sliding contact region SN is defined as a second height h2. In the present embodiment, the highest point MP1 is located on the center line LC in the R1 region of the first arc R1. That is, the first height h1 is height of the inner plate 10 on the center line LC. In the present embodiment, the highest point MP2 is located on the lines La and Lb that pass through the centers Oa and Ob of the pin holes 15a and 15b and are orthogonal to the pitch line PL. An arc portion of the outer plate 15 including the highest point MP2 and the vicinity of the highest point MP2 is the second sliding contact region S2 described above. Positions of the highest points MP1 and MP2 are not limited to those in the present embodiment. The highest point MP1may exist at a position shifted in the pitch line PL direction from the center line LC. The highest points MP2 may exist at positions shifted in the pitch line PL direction from the lines La and Lb.

The first height h1 and the second height h2 are set to satisfy a relationship of h1 > h2. When a relationship of h1 > h2 holds, the first sliding contact region S1 of the inner plate 10 is in sliding contact with the guide member 4 in preference to the outer plate 15. That is, since the inner plate 10 protrudes from the outer plate 15 by a height difference Δh = h1 - h2, more specifically, in the inner plate 10, a portion protruding toward the shoe 8a with respect to an imaginary line SL connecting the highest points MP2 adjacent to each other of the outer plate 15 is defined as the first sliding contact region S1, the first sliding contact region S1 comes into contact with a shoe surface of the guide member 4 in preference to the second sliding contact region S2. In the present embodiment, since the first sliding contact region S1 is formed in a range shorter than the chain pitch TP, friction with respect to the guide member 4 can be reduced. The height difference Δh, which is a difference between h1 and h2, may be appropriately set, but can be set in a range of 0.1 mm to 0.27 mm, for example.

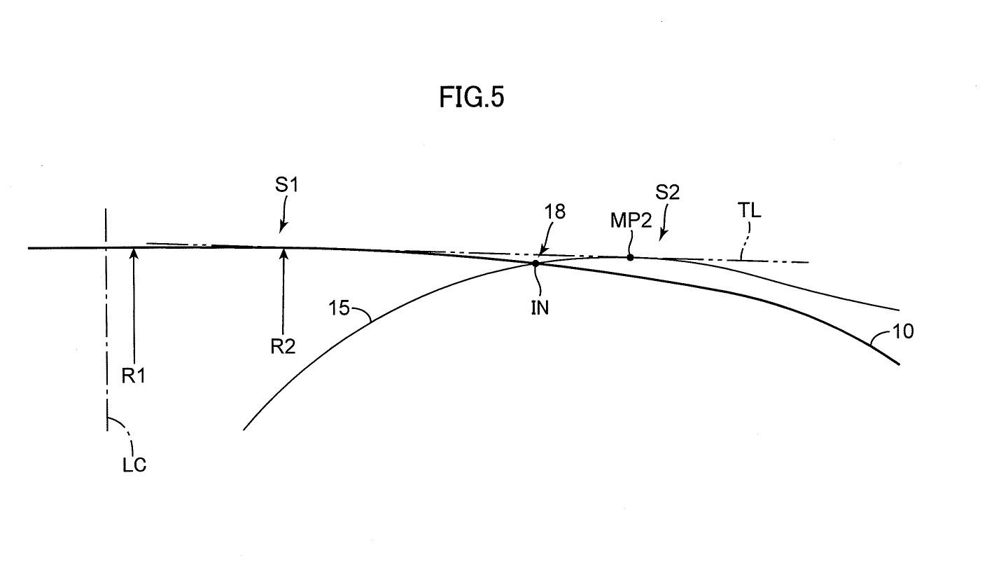

The timing chain 5 includes a depressed portion 18 that stores lubricating oil. FIG. 5 is an enlarged view of a main part of FIG. 4 for describing the depressed portion 18. FIG. 5 shows a virtual common tangent line TL connecting an arc constituting the first sliding contact region S1 and an arc constituting the second sliding contact region S2. The depressed portion 18 is defined by the common tangent line TL, an outer contour line of the inner plate 10, and an outer contour line of the outer plate 15 in a side view of the timing chain 5. The depressed portion 18 is a substantially V-shaped recessed portion having a large opening width, which is located between the first sliding contact region S1 and the second sliding contact region S2, and has an intersection IN of outer contour lines of the inner plate 10 and the outer plate 15 as a deepest portion.

The depressed portion 18 can be used as an accumulation region of lubricating oil. In the present embodiment, the first sliding contact region S1 having a highest height from the pitch line PL is formed in a range shorter than the chain pitch TP, and a contact area with the guide member 4 is small. For this reason, contact surface pressure at a contact portion where the first sliding contact region S1 is in contact with the guide member 4 is high, and oil film thickness of lubricating oil interposed between the first sliding contact region S1 and the guide member 4 tends to be small. In the present embodiment, the depressed portion 18 in which lubricating oil can be accumulated exists between the first sliding contact region S1 and the second sliding contact region S2. An oil reservoir generated in the depressed portion 18 can be used as a supply source of lubricating oil to the first sliding contact region S1. Therefore, oil film breakdown of the timing chain 5 can be suppressed, and as a result, wear of the guide member 4 can be suppressed.

### Achieving both reduction of friction and suppression of wear of guide

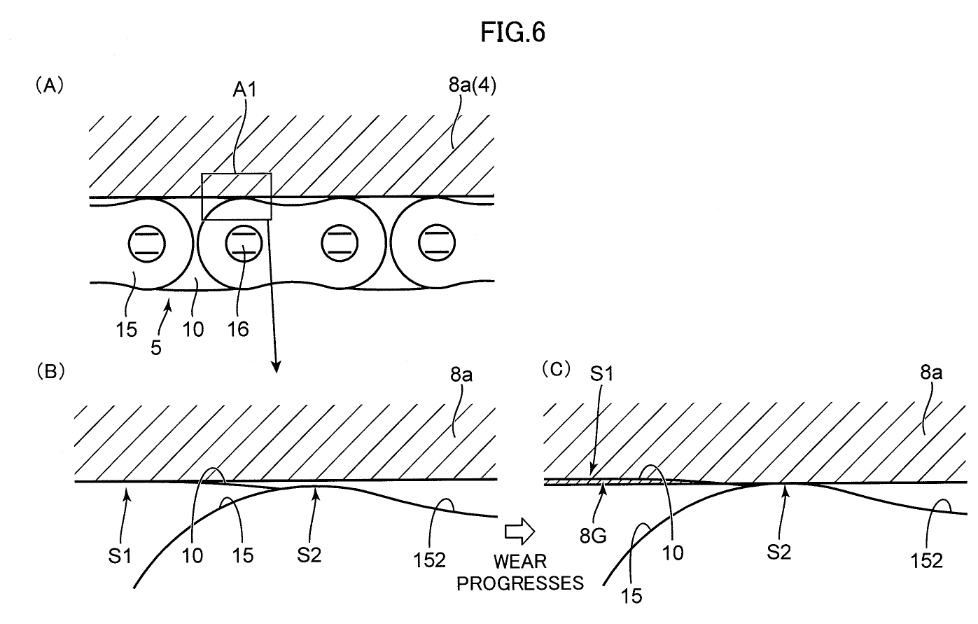

According to the timing chain 5 of the present embodiment, it is possible to achieve both reduction of friction with respect to the guide member 4 and suppression of wear of the guide member 4. This point will be described with reference to the diagrams (A), (B), and (C) of FIG. 6. In an upper diagram (A) of FIG. 6, the timing chain 5 and the shoe 8a of the tensioner arm 8 which is one of the guide members 4 are illustrated. Lower diagrams (B) and (C) of FIG. 6 are enlarged views of a portion A1 of the upper diagram (A). The diagram (B) of the lower diagrams is a schematic diagram showing a contact state of the timing chain 5 with respect to the shoe 8a at an initial use stage of the timing chain transmission device 1, and the diagram (C) is a schematic view showing the contact state after progress of wear of the shoe 8a.

As illustrated in FIG. 4, the first height h1 of the first sliding contact region S1 and the second height h2 of the second sliding contact region S2 have a relationship of h1 > h2. For this reason, in the initial use stage shown in the diagram (B) of FIG. 6, the first sliding contact region S1 of the inner plate 10 is in sliding contact with the shoe 8a as a guide in preference to the second sliding contact region S2 of the outer plate 15. Here, length in a direction along the pitch line PL of the first sliding contact region S1 is set to a length of 73% to 86% of the chain pitch TP. Therefore, it is possible to achieve both reduction of friction of the timing chain 5 with respect to the shoe 8a and suppression of wear of the guide member 4 in a well-balanced manner.

Although both friction reduction and wear suppression are achieved in a well-balanced manner, the shoe 8a is gradually worn by sliding contact with the timing chain 5. As illustrated in the diagram (C) of FIG. 6, due to the wear, a shoe groove 8G formed by the first sliding contact region S1 of the inner plate 10 is generated in the shoe 8a.

In the non-sliding contact region SN of the inner plate 10, the outer plate 15 has a greater height. For this reason, when wear of the shoe 8a progresses and the shoe groove 8G becomes deep, the second sliding contact region S2 of the outer plate 15 also comes into sliding contact with the shoe 8a. That is, as wear progresses as shown in the diagram (C) of FIG. 6, the first sliding contact region S1 and the second sliding contact region S2 come into sliding contact with the shoe 8a. As a result, surface pressure against the shoe 8a is dispersed by the inner plate 10 and the outer plate 15, and progress of wear of the shoe 8a and uneven wear can be suppressed.

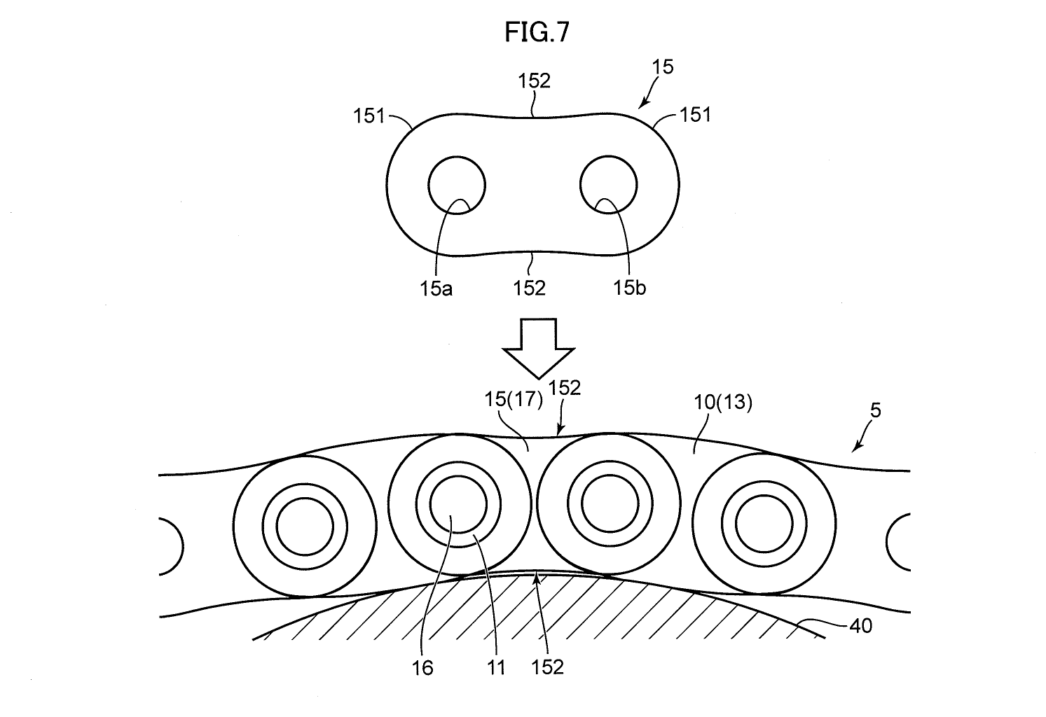

Even in a situation where both the inner plate 10 and the outer plate 15 come into contact with the shoe 8a, a shape of the outer plate 15 contributes to reduction of friction. An upper diagram of FIG. 7 is a side view of a single body of the outer plate 15, and a lower diagram of FIG. 7 is a view illustrating a sliding contact state between a guide member 40 having a small radius of curvature and the timing chain 5. As described above with reference to FIG. 3, the outer plate 15 includes a pair of the circular portions 151 including the pin holes 15a and 15b, and the recessed portion 152 that is a narrowed portion between a pair of the circular portions 151. The second sliding contact region S2 is located on both sides of the recessed portion 152.

As illustrated in the diagram (C) of FIG. 6, even if the shoe groove 8G becomes deep to an extent that the outer plate 15 comes into sliding contact with the shoe 8a, only an arc portion forming the second sliding contact region S2 comes into contact with the shoe 8a in the outer plate 15 in actuality. This is because the outer plate 15 does not have an elliptical shape with a bulge on a long side, and the recessed portion 152 that is a narrowed portion between a pair of the second sliding contact regions S2 exists. Since the outer plate 15 has a narrowed shape, even in a case where the timing chain 5 is guided by the guide member 40 having a small radius of curvature, the recessed portion 152 does not become a sliding contact portion, and only an arc portion of the second sliding contact region S2 comes into sliding contact in actuality. Furthermore, the second sliding contact region S2 is formed in an arc shape having the outer plate highest point MP2 as a vertex. Therefore, even in a situation where not only the inner plate 10 but also the outer plate 15 comes into sliding contact with a guide member due to progress of wear, increase in friction can be suppressed.

According to the present embodiment, since the above function is achieved, it is possible to provide the timing chain 5 that can achieve both reduction of friction with respect to the guide member 4 including the shoe 8a and suppression of wear of the guide member 4 and is excellent in traveling stability over a long period of time. In particular, when length in a direction along the pitch line PL of the first sliding contact region S1 is set to a length of 73% to 86% of the chain pitch TP, suppression of surface pressure applied to the guide member 4 by the first sliding contact region S1 and suppression of friction with respect to the guide member 4 can be more favorably achieved.

The embodiment described above includes an invention shown below.

A chain according to one aspect of the present invention is a chain including a plurality of outer links including a pair of outer plates and a pair of pins connecting the pair of outer plates, and a plurality of inner links including a pair of inner plates and a pair of bushings connecting the pair of inner plates, the outer links and the inner links being alternately connected by insertion of the pins into the bushings, in which the inner plate includes a back surface having a first sliding contact region that comes into sliding contact with a guide that guides the chain when the chain is driven, and a non-sliding contact region that does not come into sliding contact with the guide, the first sliding contact region is formed in a range shorter than a chain pitch by a plurality of arcs that bulge in a same direction, in the first sliding contact region, the inner plate has a height greater than a height of the outer plate in terms of height from a pitch line connecting centers of a pair of pin holes that are opened in the outer plate and through which the pair of pins pass, in the non-sliding contact region, the outer plate has a height greater than a height of the inner plate in terms of height from the pitch line, and when a height from the pitch line to a highest point of the inner plate in the first sliding contact region is defined as a first height h1, and a height from the pitch line to a highest point of the outer plate in the non-sliding contact region is defined as a second height h2, a relationship of h1 > h2 is satisfied.

According to this aspect, since the relationship of h1 > h2 holds, the first sliding contact region of the inner plate is in sliding contact with the guide in preference to the outer plate. Then, since the first sliding contact region is formed in a range shorter than a chain pitch, friction with respect to the chain guide can be reduced. On the other hand, wear of the guide due to the sliding contact is inevitable. Here, since the outer plate has a greater height in the non-sliding contact region of the inner plate, the outer plate may also come into sliding contact with the guide depending on a change in a traveling state of the chain. For this reason, surface pressure with respect to the guide is dispersed by the inner plate and the outer plate, and it is possible to suppress the progress of wear of the guide and uneven wear. Therefore, it is possible to provide a chain that can achieve both reduction of friction with respect to the chain guide and suppression of wear of the chain guide, and is excellent in traveling stability over a long period of time.

In the above chain, the first sliding contact region desirably has a length of 73% to 86% of the chain pitch in a length in a direction along the pitch line.

According to this aspect, since the length with respect to the chain pitch of the first sliding contact region is set within the above range, it is possible to more favorably achieve suppression of surface pressure applied to the guide by the first sliding contact region and suppression of friction with respect to the guide of the first sliding contact region.

In the chain described above, the first sliding contact region desirably includes a first arc extending to both sides across a center line extending in a direction orthogonal to the pitch line of the inner plate and a pair of second arcs extending outward from both ends of the first arc, and the first height is desirably a height on the center line.

In particular, a radius of the first arc is desirably greater than a radius of the second arc, and a length occupied by the first arc in the first sliding contact region is desirably a length of 5% to 48% of a total length of the first sliding contact region in a direction along the pitch line.

Reduction of friction with respect to the guide and suppression of wear of the guide are originally conflicting objects. According to the above aspect, it is possible to realize the friction reduction and the wear suppression in a well-balanced manner.

In the above chain, a region including a portion of the second height h2 in the outer plate is desirably a second sliding contact region including an arc that can be slidably contacted with the guide.

According to this aspect, even when a state where the second sliding contact region of the outer plate comes into contact with the guide is generated due to a traveling situation of the chain or the like, since the second sliding contact region has a shape including an arc, friction against the guide can be suppressed. Further, since the second sliding contact region comes into sliding contact with the guide together with the first sliding contact region of the inner plate, it is possible to contribute to suppression of surface pressure on the guide and to suppress wear of the guide.

In the chain described above, a depressed portion defined by a common tangent line connecting an arc constituting the first sliding contact region and an arc constituting the second sliding contact region, an outer contour line of the inner plate, and an outer contour line of the outer plate is desirably provided in a side view of the chain.

According to this aspect, the depressed portion can be used as an accumulation region of lubricating oil. Therefore, oil film breakdown of the chain can be suppressed, and as a result, wear of the guide can be suppressed.

In the above chain, a difference between the first height h1 and the second height h2 is desirably in a range of 0.1 mm to 0.27 mm.

According to this aspect, surface pressure with respect to the guide of the chain can be further suppressed. In a case where a groove is formed in the guide by wear due to sliding contact of the first sliding contact region, the second sliding contact region also comes into sliding contact with the guide. By setting a difference between h1 and h2 within the above numerical range, a timing at which both the first sliding contact region and the second sliding contact region come into sliding contact with the guide can be optimized, and progress of wear of the guide can be suppressed. Therefore, stable traveling of the chain can be maintained.

In the chain described above, the outer plate desirably has a recessed portion recessed toward the pitch line in a central region in a direction along the pitch line, and the second sliding contact region is desirably arranged at both end portions of the recessed portion.

According to this aspect, the outer plate has a shape having a recessed portion between a pair of the second sliding contact regions. For this reason, in the outer plate, a region other than the second sliding contact region is less likely to come into sliding contact with the guide. Therefore, for example, even in a case where a radius of curvature of the guide is relatively small, a central region of the outer plate is less likely to come into sliding contact with the guide. Therefore, friction with respect to the guide is easily reduced.

According to the present invention, it is possible to provide a chain capable of achieving both reduction of friction with respect to a chain guide and suppression of wear of the chain guide.

This application is based on Japanese Patent application No. 2024-169378 filed in Japan Patent Office on September 27, 2024, the contents of which are hereby incorporated by reference.

Although the present invention has been fully described by way of example with reference to the accompanying drawings, it is to be understood that various changes and modifications will be apparent to those skilled in the art.Therefore, unless otherwise such changes and modifications depart from the scope of the present invention hereinafter defined, they should be construed as being included therein.

1. A chain comprising:
a plurality of outer links including a pair of outer plates and a pair of pins connecting the pair of outer plates; and a plurality of inner links including a pair of inner plates and a pair of bushings connecting the pair of inner plates, the outer links and the inner links being alternately connected by insertion of the pins into the bushings, wherein
the inner plate includes a back surface having a first sliding contact region that comes into sliding contact with a guide that guides the chain when the chain is driven, and a non-sliding contact region that does not come into sliding contact with the guide,
the first sliding contact region is formed in a range shorter than a chain pitch by a plurality of arcs that bulge in a same direction,
in the first sliding contact region, the inner plate has a height greater than a height of the outer plate in terms of height from a pitch line connecting centers of a pair of pin holes that are opened in the outer plate and through which the pair of pins pass,
in the non-sliding contact region, the outer plate has a height greater than a height of the inner plate in terms of height from the pitch line, and
when a height from the pitch line to a highest point of the inner plate in the first sliding contact region is defined as a first height h1, and a height from the pitch line to a highest point of the outer plate in the non-sliding contact region is defined as a second height h2, a relationship of h1 > h2 is satisfied.

2. The chain according to claim 1, wherein
the first sliding contact region has a length of 73% to 86% of the chain pitch in a length in a direction along the pitch line.

3. The chain according to claim 1, wherein
the first sliding contact region includes a first arc extending to both sides across a center line extending in a direction orthogonal to the pitch line of the inner plate and a pair of second arcs extending outward from both ends of the first arc, and
the first height is a height on the center line.

4. The chain according to claim 3, wherein
a radius of the first arc is greater than a radius of the second arc, and
a length occupied by the first arc in the first sliding contact region is a length of 5% to 48% of a total length of the first sliding contact region in a direction along the pitch line.

5. The chain according to claim 1, wherein
a region including a portion of the second height h2 in the outer plate is a second sliding contact region including an arc that can come into sliding contact with the guide.

6. The chain according to claim 5, wherein
a depressed portion defined by a common tangent line connecting an arc constituting the first sliding contact region and an arc constituting the second sliding contact region, an outer contour line of the inner plate, and an outer contour line of the outer plate is provided in a side view of the chain.

7. The chain according to claim 1, wherein
a difference between the first height h1 and the second height h2 is in a range of 0.1 mm to 0.27 mm.

8. The chain according to claim 5, wherein
the outer plate has a recessed portion recessed toward the pitch line in a central region in a direction along the pitch line, and the second sliding contact region is arranged at both end portions of the recessed portion.
